(19) United States
(12) Patent Application Publication
(10) Pub. No.: US 2007/0081666 A1
(43) Pub. Date: Apr. 12, 2007

(54) Transmitted information verification device and transmitted information verification method

(75) Inventor: Toshihiro Shima, Shiojiri-shi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/543,152

(22) Filed: Oct. 5, 2006

(30) Foreign Application Priority Data
Oct. 6, 2005 (JP) 2005-293438

(51) Int. Cl. H04L 9/30

(52) U.S. Cl. 380/30

(57) ABSTRACT

A transmitted information verification device of the invention includes: a transmitted information capture module that captures encrypted transmission object information transferred on a network, as encrypted transmitted information; a comparative information generation module that encrypts transmission object information, which is included in an encryption record created by a managed device, with a cipher key used for encryption of the transmission object information in the managed device to generate comparative information; and a transmitted information verification module that compares the encrypted transmitted information with the generated comparative information for verification. This arrangement effectively verifies the absence of any piece of information that is not to be transmitted but is to be strictly kept in the user, for example, the user's any private or confidential piece of information, in the transmitted information that is transferred on the network from the managed device to a management server.

### BACKGROUND OF THE INVENTION

1. Field of the Invention

The present invention relates to a verification technique adopted in a management system where a management server manages a managed device, such as a printer, connecting therewith. The verification technique verifies the content of encrypted information transmitted from the managed device to the management server.

2. Description of the Related Art

With recent advancement of the network-related technology using the Internet and local area networks, a device management system has been proposed where a management server connecting with a managed device via a global network, such as the Internet, manages the managed device connected to a local area network (see, for example, Japanese Patent Laid-Open Gazette No. 2004-185351). In this proposed device management system, the managed device collects specific pieces of monitor information including its working conditions and sends the collected monitor information to the management server. The management server analyzes the received monitor information to obtain required pieces of information including the working conditions of the managed device.

The information sent from the managed device to the management server may include the user's private or confidential pieces of information or the system administrator's essential pieces of information that prohibit any falsification or alteration. The information sent from the managed device to the management server is thus generally encrypted in a specific manner that allows decryption only by the management server having a decoding key. Namely the user of the managed device is not allowed to decode the encrypted information sent from the managed device to the management server via the Internet. The user may thus naturally be anxious about the intentional or unintentional inclusion of specific pieces of information that are not to be transmitted but are to be strictly kept in the user, for example, business-related confidential or classified information or the user's personal data, in the externally transmitted information.

For example, the managed device is a printer connected to an intra-company local area network. The printer receives confidential or classified document information from a personal computer connecting with the network to print confidential or classified documents. In this case, it is technically possible that the managed device sends the confidential or classified document information to the management server.

The user accordingly desires to objectively verify the absence of any piece of information that is not to be transmitted but is to be strictly kept in the user, for example, the user's any confidential or private piece of information, in the information sent from the managed device to the management server.

### SUMMARY OF THE INVENTION

The object of the invention is thus to eliminate the drawbacks of the prior art technique and to provide a technique of verifying that transmitted information from a managed device to a management server connecting with the managed device via a network does not include any piece of information that is not to be transmitted but is to be strictly kept in the user, for example, the user's any private or confidential piece of information.

In order to attain at least part of the above and the other related objects, the present invention is directed to a transmitted information verification device that verifies content of encrypted transmission object information sent from a managed device to a management server, where the managed device connecting with the management server via a network encrypts transmission object information, which is to be sent to the management server, to generate the encrypted transmission object information.

The transmitted information verification device includes: a transmitted information capture module that captures the encrypted transmission object information transferred on the network, as encrypted transmitted information; a comparative information generation module that encrypts transmission object information, which is included in an encryption record created by the managed device, with a cipher key used for encryption of the transmission object information in the managed device to generate comparative information; and a transmitted information verification module that compares the encrypted transmitted information with the generated comparative information for verification.

The transmitted information verification device of the invention verifies that the encrypted information transmitted from the managed device to the management server does not include any other piece of information than the transmission object information in the encryption record created by the managed device. The transmitted information verification device analyzes the transmission object information included in the encryption record and proves that the analyzed transmission object information does not include any piece of information that is not to be transmitted but is to be strictly kept in the user, for example, the user's any private or confidential piece of information. This verifies no transmission of any such private or confidential piece of information to the management server.

In one preferable embodiment of the transmitted information verification device of the invention, the cipher key used in the managed device is stored as part of the encryption record in correlation to the transmission object information encrypted with the cipher key. The comparative information generation module encrypts the transmission object information included in the encryption record with the cipher key correlated to the transmission object information to generate the comparative information.

This arrangement enables the comparative information to be generated from the encryption record. When the cipher key is not fixed but is changed, this arrangement allows easy identification of the cipher key used for encryption of the transmission object information.

The present invention is also directed to a managed device that encrypts transmission object information and transmits the encrypted transmission object information to a management server connecting with the managed device via a network.

The managed device stores the encrypted transmission object information in correlation to a cipher key used for encryption of the transmission object information, as an encryption record.

The managed device of the invention stores the encrypted transmission object information in correlation to the cipher key used for encryption of the transmission object information, as the encryption record obtained by encrypting the transmission object information. The encryption record is effectively verifiable by the transmitted information verification device of the invention. It can be verified that the encrypted information transmitted from the managed device to the management server does not include any other piece of information than the transmission object information in the encryption record. The transmitted information verification device analyzes the transmission object information included in the encryption record and proves that the analyzed transmission object information does not include any piece of information that is not to be transmitted but is to be strictly kept in the user, for example, the user's any private or confidential piece of information. This verifies no transmission of any such private or confidential piece of information to the management server.

The transmitted information verification device or the managed device of the invention is not restricted to have all the characteristics described above but may be constructed with omission of some of the characteristics or with various combinations of the characteristics. The invention is not restricted to the transmitted information verification device or the managed device but is also actualized by a device management system including a transmitted information verification device, a managed device, and a management server. The technique of the invention may be actualized by diversity of other applications including a transmitted information verification method, a transmitted information monitoring method, computer programs that attain the transmitted information verification device, the managed device, the transmitted information verification method, and the transmitted information monitoring method, recording media in which such computer programs are recorded, and data signals that include such computer programs and are embodied in carrier waves. Any of the additional characteristics described above may be adopted in any of these other applications.

In the applications of the invention as the computer programs and the recording media in which the computer programs are recorded, the invention may be given as a whole program to control the operations of the transmitted information verification device or the managed device or as a partial program to exert only the characteristic functions of the invention. Available examples of the recording media include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 shows the general configuration of a device management system that includes a transmitted information verification device ICS as one embodiment of the invention and monitors information transmitted from managed devices to a management server SV;

FIG. 2 schematically illustrates the structure of a printer PRT1 as one managed device;

FIG. 3 shows encryption of transmission object information executed by a server access control module included in the printer PRT1;

FIG. 4 shows a flow of transmitted information from the printer PRT1 to the management server SV;

FIG. 5 is a flowchart showing an encryption record creating process executed by an encryption record management module included in the printer PRT1;

FIG. 6 shows an encryption record stored in an encryption record storage unit included in the printer PRT1;

FIG. 7 schematically illustrates the structure of the transmitted information verification device ICS;

FIG. 8 is a flowchart showing a transmitted information monitoring process executed by the transmitted information verification device ICS;

FIG. 9 shows encrypted transmitted information stored in a transmitted information storage unit included in the transmitted information verification device ICS; and

FIG. 10 shows comparative information stored in a comparative information storage unit included in the transmitted information verification device ICS.

### DESCRIPTION OF THE PREFERRED EMBODIMENTS

One mode of carrying out the invention is described below as a preferred embodiment in the following sequence with reference to the accompanied drawings:

A. Embodiment

A1. General Description of Device Management System and Transmitted Information Verification Device

A2. Structure of Managed Device

A3. Encrypting Process by Server Access Control Module

A4. Encryption Record Creating Process by Encryption Record Management Module

A5. Structure of Transmitted Information Verification Device

A6. Transmitted Information Monitoring Process by Transmitted Information Verification Device

A7. Effects of Embodiment

B. Modifications

### A. EMBODIMENT

### A1. GENERAL DESCRIPTION OF DEVICE MANAGEMENT SYSTEM AND TRANSMITTED INFORMATION VERIFICATION DEVICE

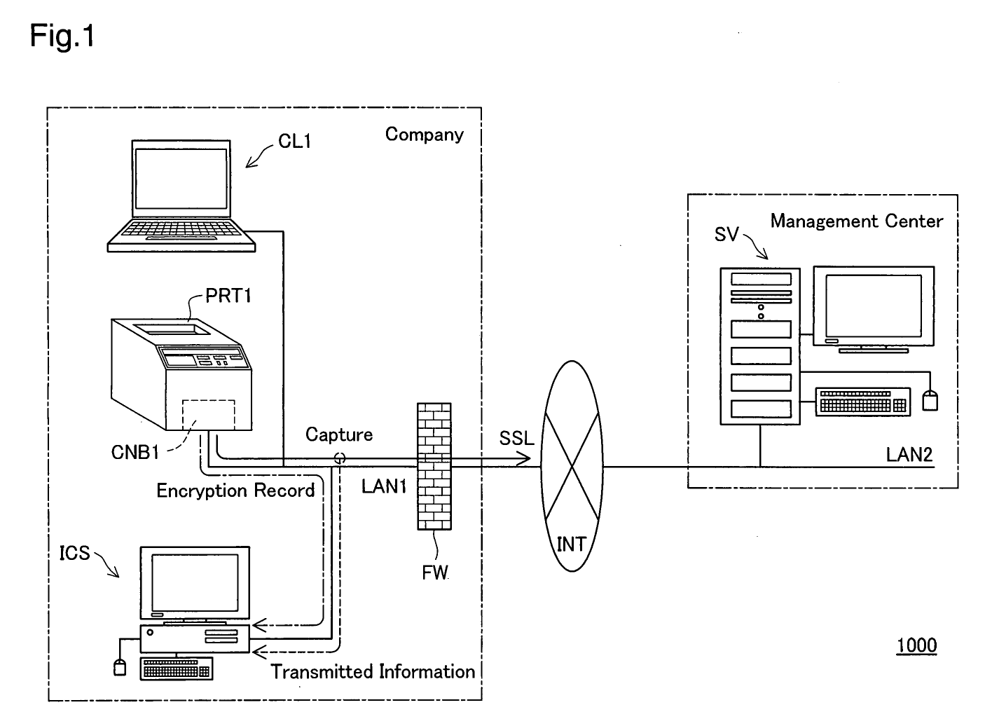

FIG. 1 shows the general configuration of a device management system 1000 that includes a transmitted information verification device ICS as one embodiment of the invention and monitors information transmitted from managed devices to a management server SV.

The device management system 1000 connects an intra-company local area network LAN1 established in a company with a local area network LAN2 established in a management center via the Internet INT. The management server SV linked to the local area network LAN2 in the management center accordingly establishes connection with the intra-company local area network LAN1.

In the illustrated example, only one intra-company local area network LAN1 is connected to the management server SV. This is, however, not restrictive but is only illustrative. The number of intra-company local area networks connected to the management server SV may be set arbitrarily.

Not only the management server SV but various devices (not shown) generally connectable with the network, for example, client computers (hereafter simply referred to as ‘clients’), servers, and printers are connectable with the local area network LAN2 in the management center.

Multiple clients and multiple laser printers (hereafter simply referred to as ‘printers’) as managed devices are connected to the intra-company local area network LAN1. The illustrated example includes only one printer PRT1 and only one client CL1, although the numbers of the clients and the printers may be set arbitrarily. The transmitted information verification device ICS is also connected to the local area network LAN1.

Communication between the individual devices connecting with these networks LAN1 and LAN2 follows the known TCP/IP protocol. An IP address is allocated to each device. Communication data transmitted from a sender device to a receiver device includes an IP address of the sender device (sender IP address) and an IP address of the receiver device (receiver IP address). The communication data is sent to the receiver device having the receiver IP address.

A custom network board CNB1 is mounted on the printer PRT1 as a managed device. The custom network board CNB1 has a server access function and a device monitoring function, in addition to the general communication functions.

The device monitoring function of the custom network board CNB1 monitors the operations of the printer PRT1 with the custom network board CNB1 mounted thereon.

The server access function of the custom network board CNB1 sends information to the management server SV and receives information from the management server SV. For example, printer monitor information acquired by the device monitoring function of the custom network board CNB1 is sent to the management server SV. The server access function of the custom network board CNB1 sends request information from the printer PRT1 to the management server SV, while receiving request information from the management server SV to the printer PRT1.

There is a firewall FW provided between the intra-company local area network LAN1 and the Internet INT. The firewall FW prohibits access from the Internet INT to the local area network LAN1. Namely the management server SV is not allowed to make access to the printer PRT1. The printer PRT1 adopts the HTTP protocol (Hyper Text Transfer Protocol) and makes access to the management server SV via the firewall FW to establish communication with the management server SV. For the enhanced communication security between the printer PRT1 and the management server SV, encrypted communication based on HTTPS (Hyper Text Transfer Protocol over SSL) as one application of the HTTP protocol is made between the printer PRT1 and the management server SV. Information is encrypted prior to transmission from the printer PRT1 to the management server SV.

The printer PRT1 has an encryption record management function to correlate unencrypted plain text information, which is to be sent to the management server SV, to information on cipher keys used for encryption of the plain text information and store the correlation as an encryption record. The stored encryption record is supplied to the transmitted information verification device ICS via the local area network LAN1.

A standard network board (not shown) is mounted on the management server SV and has the general communication functions to send and receive communication data to and from the devices connected to the local area network LAN2.

The management server SV additionally has a device access function to send and receive communication data to and from the printer PRT1 having the server access function. At polling from the printer PRT1 to the management server SV, the management server SV receives request information from the printer PRT1 and sends request information to the printer PRT1. The management server SV receives the printer monitor information from the printer PRT1 and accumulates the received printer monitor information into a database (not shown).

As described above, in the device management system 1000, the printer monitor information of the printer PRT1 accessible to the management server SV is sent from the printer PRT1 placed in the company to the management sever SV placed in the management center and is accumulated for management in the management server SV. The management server SV sends request information to the printer PRT1 in response to polling from the printer PRT1 to the management server SV. The printer PRT1 receives the request information and executes a series of operations specified by the received request information.

The transmitted information verification device ICS captures transmitted information that is transferred on the local area network LAN1 from the printer PRT1 to the management server SV and generates encrypted transmission object information from the captured transmitted information as encrypted transmitted information. The transmitted information verification device ICS requests transmission of an encryption record and acquires the encryption record sent from the printer PRT1. The transmitted information verification device ICS encrypts transmission object information included in the acquired encryption record with a correlated cipher key to generate comparative information. Comparison between the encrypted transmitted information and the generated comparative information determines whether the transmitted information includes any other piece of information than the transmission object information of the encryption record.

### A2. STRUCTURE OF MANAGED DEVICE

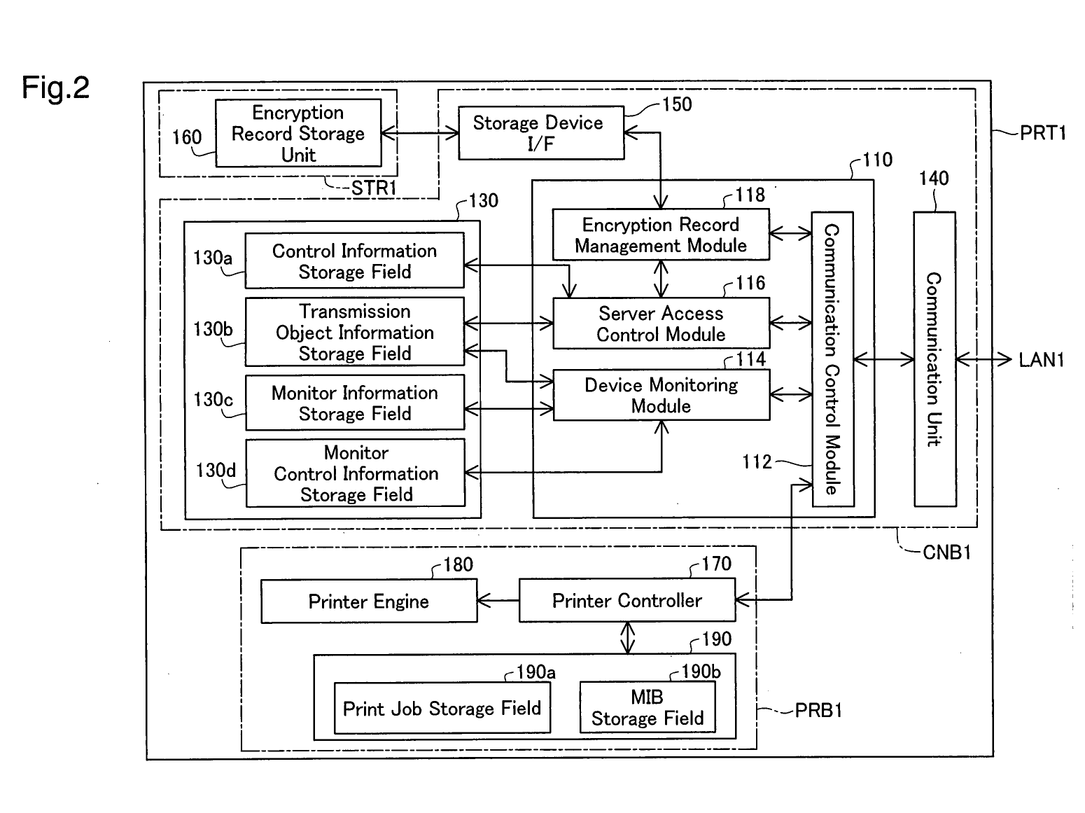

FIG. 2 schematically illustrates the structure of the printer PRT1 as one managed device. The printer PRT1 includes a printer main body PRB1 that performs printing operations, the custom network board CNB1, and a storage device STR1.

The storage device STR1 has an encryption record storage unit 160 to store an encryption record created as described later. Any of diverse memory devices, for example, HD (hard disks) and DVD (digital versatile disks) may be used for the storage device STR1. In the illustrated example, the storage device STR1 is an HD.

The printer main body PRB1 mainly includes a printer engine 180, a printer controller 170, and a memory 190.

The printer engine 180 is a mechanism that actually performs printing operations. The printer controller 170 is constructed by a computer including a CPU, a RAM, and a ROM (not shown). The printer controller 170 receives print job data from the custom network board CNB1 and stores the received print job data into a print job storage field 190a of the memory 190, while reading the print job data from the print job storage field 190a of the memory 190 and controlling the printer engine 180 to perform printing operations according to the print job data. The printer controller 170 also detects information regarding the total number of prints, the consumed quantities or the remaining quantities of toners, and the print status of each print job, for example, the number of copies printed and the current status like ‘under printing’, ‘end of printing’, or ‘paper jam’ and stores the detected information in the form of an MIB (management information base) into an MIB storage field 190b of the memory 190. The MIB includes commonly specified standard information of the printer main body PRB1 and individual information specified by the manufacturer.

The custom network board CNB1 includes a CPU 110, a memory 130, a communication unit 140, and a storage device I/F 150.

The storage device I/F 150 works as an interface to control the operations of writing data into the storage device STR1 and reading data from the storage device STR1.

The communication unit 140 works as a communication device to make communication via the local area network LAN1.

The memory 130 has multiple information storage fields including a control information storage field 130a, a transmission object information storage field 130b, a monitor information storage field 130c, and a monitor control information storage field 130d.

The CPU 110 works as various functional blocks including a communication control module 112, a device monitoring module 114, a server access control module 116, and an encryption record management module 118. The communication control module 112, the device monitoring module 114, the server access control module 116, and the encryption record management module 118 respectively perform the general communication functions, the device monitoring function, the server access function, and an encryption record management function. The CPU 110 reads and executes a preset computer program stored in a ROM (not shown) to attain these functional blocks as a software configuration. At least part of these functional blocks may alternatively be actualized by a hardware configuration.

The communication control module 112 changes over an effective communication protocol to be used corresponding to each communication partner and controls the communication unit 140 to make communication with the client CL1, another printer PRT, or the management server SV as the communication partner via the local area network LAN1 and the Internet INT. The communication control module 112 identifies a receiver IP address and a receiver port number included in communication data received from the communication partner, while assigning a receiver IP address and a receiver port number to communication data to be sent to the communication partner. The communication control module 112 also controls data transmission to and from the printer controller 170.

The device monitoring module 114 gives a preset command on the SNMP protocol (simple network management protocol) to the printer controller 170 via the communication control module 112 and causes the printer controller 170 to read and acquire various pieces of information regarding the operations of the printer PRT1 (hereafter may be referred to as ‘MIB information’) from the MIB stored in the MIB storage field 190b of the memory 190. The acquired MIB information is collectively stored as device monitor information into the monitor information storage field 130c of the memory 130. The device monitor information stored in the monitor information storage field 130c is converted into a specific format transmittable to the management server SV and is registered in the transmission object information storage field 130b of the memory 130 as transmission object information to be sent to the management server SV. Monitor control information is sent in advance from the management server SV and is stored in the monitor control information storage field 130d of the memory 130. The monitor control information includes information regarding the individual items of the MIB information to be acquired and information required for controlling the operations of the device monitoring module 114. The device monitoring module 114 controls the printer controller 170 to acquire the MIB information from the MIB storage field 190b of the memory 190 based on the monitor control information stored in the monitor control information storage field 130d.

The server access control module 116 identifies storage or non-storage of the transmission object information in the transmission object information storage field 130b based on working conditions stored in the control information storage field 130a. Upon identification of storage of the transmission object information, the server access control module 116 makes access to the management server SV and sends the stored transmission object information to the management server SV. The device monitor information is thus sent to the management server SV and is accumulated therein for management. The request information from the printer PRT1 to the management server SV, as well as the device monitor information, may also be registered as part of the transmission object information into the transmission object information storage field 130b of the memory 130. Like the device monitor information, the request information is monitored and is sent to the management server SV.

The server access control module 116 makes polling to the management server SV at preset polling intervals via the communication control module 112 based on the working conditions stored in the control information storage field 130a. The polling inquires about the presence or the absence of any request from the management server SV. When the inquiry identifies the presence of a request from the management server SV, the server access control module 116 receives request information (server request information) from the management server SV, analyzes the contents of the received server request information, and performs a required series of operations specified by the analyzed contents of the server request information. For example, when the request information sent from the management server SV includes the monitor control information, the server access control module 116 transfers the monitor control information to the device monitoring module 114. The device monitoring module 114 stores the received monitor control information into the monitor control information storage field 130d of the memory 130.

The server access control module 116 exchanges random digits with the management server SV and uses the exchanged random digits to create a cipher key or a session key in the course of transmission of the transmission object information stored in the transmission object information storage field 130b to the management server SV. The server access control module 116 encrypts the created session key with a public key of the management server SV that is stored in advance in the control information storage field 130a, while using the session key to encrypt the transmission object information. The encrypted session key is combined with the encrypted transmission object information and is sent to the management server SV.

The encryption record management module 118 correlates the transmission object information as plain text information prior to encryption by the server access control module 116 to the session key created for encryption of the transmission object information and prepares an encryption record including the correlation. The prepared encryption record is stored into the encryption record storage unit 160 of the storage device STR1 via the storage device I/F 150.

In response to a request from the transmitted information verification device ICS, the encryption record management module 118 sends the encryption record stored in the encryption record storage unit 160 to the transmitted information verification device ICS via the communication control module 112 and the communication unit 140.

### A3. ENCRYPTING PROCESS BY SERVER ACCESS CONTROL MODULE

The server access control module 116 performs encryption of the transmission object information including the device monitor information, prior to transmission from the printer PRT1 as the managed device to the management server SV.

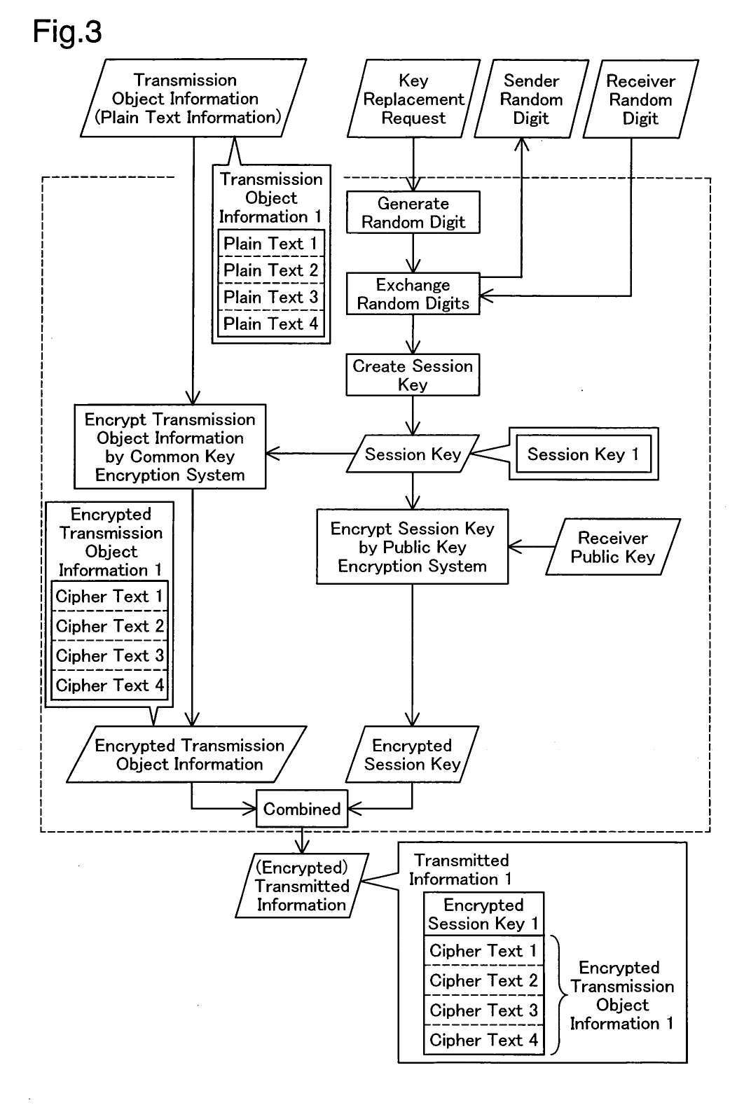

FIG. 3 shows a process of encrypting the transmission object information executed by the server access control module 116. Each rectangular block shows a ‘processing step’, and each parallelogram block shows ‘information’.

The printer PRT1 as the managed device and the management server SV generate random digits for creation of a session key, which is used for encryption, at regular intervals and exchange the generated random digits. In the illustrated system configuration, the printer PRT1 and the management server SV exchange random digits in response to a key replacement request given by the printer PRT1 at regular intervals.

The printer PRT1 generates a random digit in response to a key replacement request and sends the generated random digit as a sender random digit (managed device random digit) to the management server SV, while receiving a receiver random digit from the management server SV. This operation exchanges the random digits individually generated in the printer PRT1 and in the management server SV. The management server SV receives the sender random digit, generates a random digit, and sends the generated random digit as the receiver random digit (management server random digit) to the printer PRT1 as the managed device that has sent the sender random digit.

A session key is created from the exchanged sender random digit and receiver random digit according to a predetermined algorithm. In the illustrated example, ‘session key 1’ is created from the exchanged random digits. The created session key is stored in the control information storage module 130a (see FIG. 2). The storage in the control information storage module 130a is updated every time a new session key is created in response to a key replacement request.

As described above, the printer PRT1 as the sender and the management server SV as the receiver exchange the individually generated random digits. The printer PRT1 then creates a session key or a cipher key required for encryption of the transmission object information as plain text information by the common key encryption system. The created session key is used for the following two processing operations.

The first processing operation regards the created session key as a plain text to be encrypted and encrypts the session key with a public key (receiver public key) open to the public by the management server SV to give an encrypted session key.

The second processing operation regards the transmission object information as plain text information and encrypts the transmission object information with the created session key by the common key encryption system to generate encrypted transmission object information.

Encryption by the common key encryption system sets a predetermined information volume, for example, 64 bits, to one processing unit (hereafter may also be referred to as ‘encryption process unit’). The transmission object information having a greater information volume than the encryption process unit is divided into multiple plain text blocks corresponding to multiple encryption process units. The multiple plain text blocks are sequentially subjected to encryption. In the illustrated example of FIG. 3, transmission object information 1 specified as plain text information is divided into four plain text blocks (plain text 1 to plain text 4) corresponding to four encryption process units. The four plain text blocks, plain text 1 to plain text 4, are sequentially encrypted with session key 1. This generates encrypted transmission object information 1 consisting of four cipher text blocks (cipher text 1 to cipher text 4).

Combination of the encrypted session key with the encrypted transmission object information gives transmitted information, which is to be sent to the management server SV. In the illustrated example of FIG. 3, attachment of encrypted session key 1 on the head of encrypted transmission object information 1 gives transmitted information 1.

As described above, the server access control module 116 encrypts the transmission object information as the plain text information to generate the encrypted transmitted information and sequentially sends the encrypted transmitted information to the management server SV. The transmission object information is encrypted prior to transmission to the management server SV. This desirably ensures the security of communication between the printer PRT1 as the managed device and the management server SV.

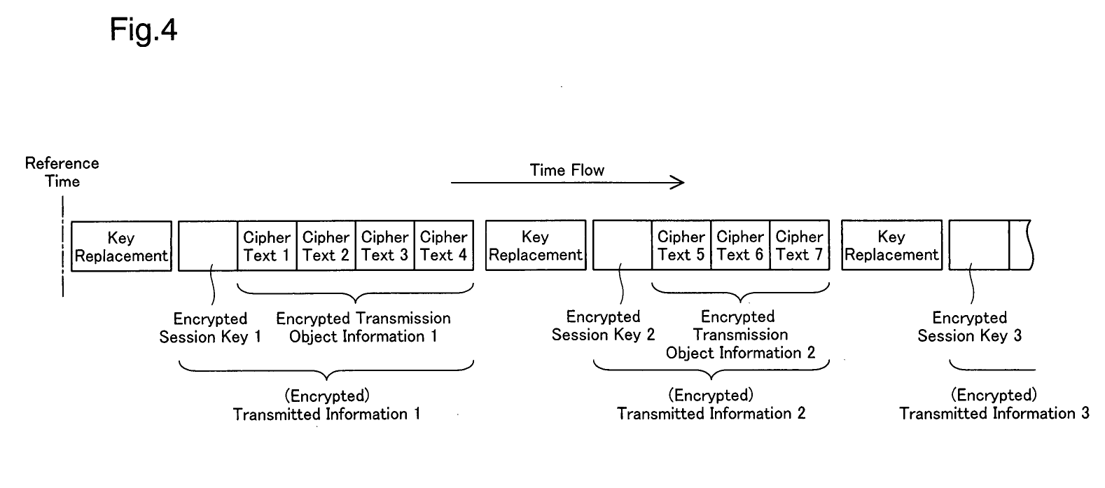

FIG. 4 shows a flow of transmitted information from the printer PRT1 to the management server SV. In the illustrated example, three sets of transmitted information (transmitted information 1 to transmitted information 3) are sequentially sent from the printer PRT1 to the management server SV. Random digits are exchanged before transmission of each set of transmitted information. The transmission object information included in each set of transmitted information is encrypted with a different session key newly created by exchange of random digits and is combined with the different encrypted session key.

Multiple sets of transmission object information may be sent from the printer PRT1 to the management server SV between previous exchange of random digits and next exchange of random digits. No different session key is newly created during transmission of the multiple sets of transmission object information, but the same session key is used for encryption of the multiple sets of transmission object information. The multiple sets of encrypted transmission object information are accordingly sent in combination with the same encrypted session key. Transmission of the same encrypted session key plural times is, however, unnecessary. In the case of transmission of the multiple sets of transmission object information encrypted with the same session key, the encrypted session key is to be sent only once in combination with a first set of encrypted transmission object information.

### A4. ENCRYPTION RECORD CREATING PROCESS BY ENCRYPTION RECORD MANAGEMENT MODULE

The encryption record management module 118 creates the encryption record in the course of encryption of the transmission object information by the server access control module 116.

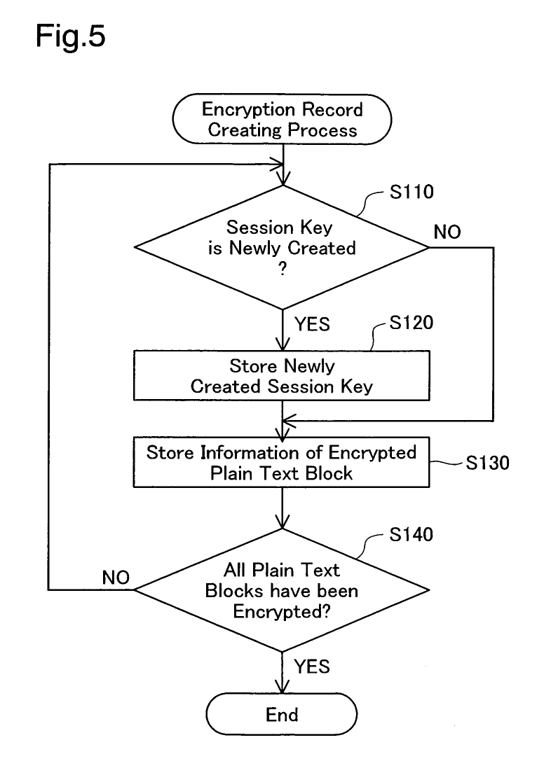

FIG. 5 is a flowchart showing an encryption record creating process executed by the encryption record management module 118.

The encryption record management module 118 starts the encryption record creating process shown in the flowchart of FIG. 5 when the server access module 116 detects storage of transmission object information in the transmission object information storage field 130b and starts generation of transmitted information.

On the start of the encryption record creating process, the encryption record management module 118 first makes an inquiry to the server access control module 116 to identify creation or non-creation of a new session key (step S110). In the case of creation of a new session key (step S110: Yes), the encryption record management module 118 receives information on the newly created session key from the server access control module 116 and stores the received information on the session key into the encryption record storage unit 160 (step S120). Information of each plain text block encrypted with the newly created session key among plural plain text blocks of transmission object information as a target of encryption is stored into the encryption record storage unit 160 (step S130). The encryption record management module 118 then determines whether all the plain text blocks in the transmission object information have been encrypted (step S140).

When there is any unencrypted plain text block (step S140: No), the encryption record creating process returns to step S110 to identify creation or non-creation of another session key. No session key is newly created (step S110: No) during encryption of plain text blocks included in the same transmission object information. In this cycle, the information of each plain text block encrypted with the session key is simply stored into the encryption record storage unit 160 (step S130). The processing of steps S110 to S130 is repeated to accumulate the information of the encrypted plain text blocks into the encryption record storage unit 160 until completed encryption of all the plain text blocks included in the same transmission object information (step S140: Yes).

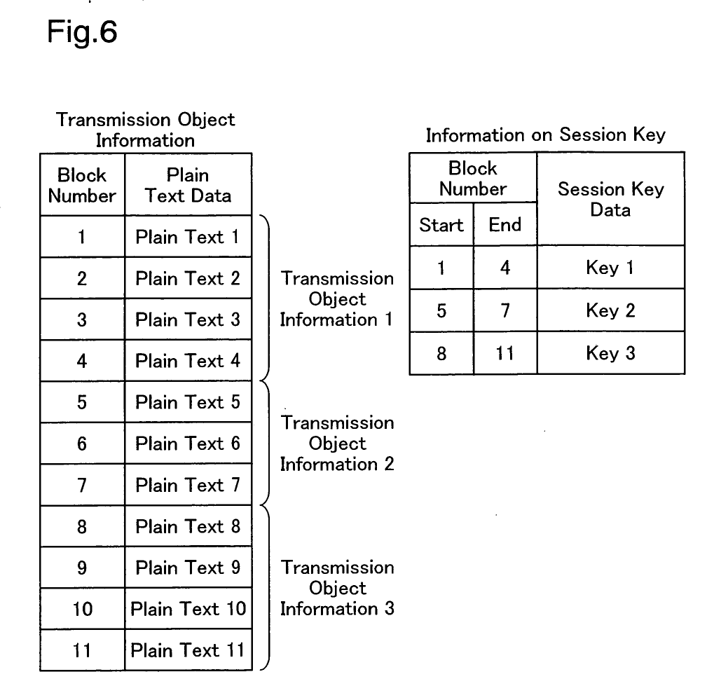

FIG. 6 shows one example of the encryption record stored in the encryption record storage unit 160. As shown in the left half of FIG. 6, sets of transmission object information divided by plain text blocks as processing units of encryption are sequentially stored in relation to their block numbers. In the illustrated example of FIG. 6, data of plain text blocks 1 to 11 are stored in relation to block numbers 1 to 11. The plain text blocks 1 to 4 constitute transmission object information 1, the plain text blocks 5 to 7 constitute transmission object information 2, and the plain text blocks 8 to 11 constitute transmission object information 3. As shown in the right half of FIG. 6, information on each session key is stored in relation to a range of plain text blocks that are encrypted with the session key. This range is specified by a start block number and an end block number. In the illustrated example of FIG. 6, information (data) on Session Keys 1, 2, and 3 are stored respectively in relation to the block numbers 1 to 4, the block numbers 5 to 7, and the block numbers 8 to 11.

The storage of the information of the respective plain text blocks in correlation to the information on the session keys in the above manner is, however, neither restrictive nor essential. The information of each plain text block may be stored in one-to-one relation to the information on a session key used for encryption of the plain text block. Any correlation technique may be adopted for the storage as long as the information of each plain text block is correlated to the information on a session key used for encryption of the plain text block in a clearly identifiable manner.

### A5. STRUCTURE OF TRANSMITTED INFORMATION VERIFICATION DEVICE

The general computer system reads and executes a preset computer program to actualize the transmitted information verification device ICS as described below.

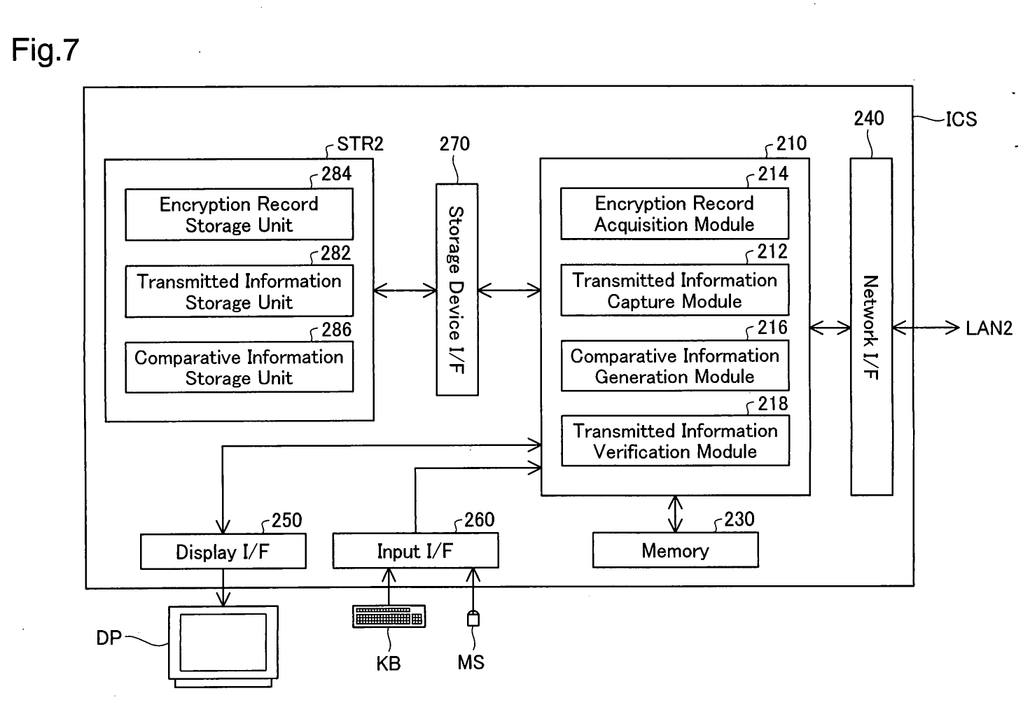

FIG. 7 schematically illustrates the structure of the transmitted information verification device ICS. The transmitted information verification device ICS mainly includes a CPU 210, a memory 230, a network I/F 240, a display I/F 250, an input I/F 260, and a storage device I/F 270.

The storage device I/F 270 works as an interface to control the operations of writing data into the storage device STR2 and reading data from the storage device STR2.

The input I/F 260 works as an interface to input data from a keyboard KB and a mouse MS, and the display I/F 250 works as an interface to display images on a monitor DP.

The network I/F 240 works as an interface to make communication with various clients via the local area network LAN2 and the Internet INT and with the printer PRT1 connected to the intra-company local area network LAN1 (see FIG. 1).

The storage device STR2 has a transmitted information storage unit 282 to store the transmitted information captured as described below, an encryption record storage unit 284 to store the encryption record acquired as described below, and a comparative information storage unit 286 to store comparative information generated as described below. Any of diverse memory devices, for example, HD (hard disks) and DVD (digital versatile disks) may be used for the storage device STR2. In the illustrated example, the storage device STR2 is an HD.

The CPU 210 reads and executes a preset computer program on the memory 230 to work as various functional blocks including a transmitted information capture module 212, an encryption record acquisition module 214, a comparative information generation module 216, and a transmitted information verification module 218. The cooperation of these functional blocks enables the whole computer system to work as the transmitted information verification device ICS. At least part of these functional blocks may alternatively be actualized by a hardware configuration. The computer program for attaining these functional blocks is stored in a memory device, for example, an internal memory device like a RAM or a ROM or an external memory device like an HD or a DVD.

The transmitted information capture module 212 receives a transmitted information-capture start command through the user's operation of the keyboard KB or the mouse MS and captures transmitted information that is transferred on the local area network LAN1 from the printer PRT1 to the management server SV (see FIG. 1). The transmitted information capture module 212 then extracts encrypted transmission object information included in the captured transmitted information and stores the encrypted transmission object information as encrypted transmitted information into the transmitted information storage unit 282 set in the storage device STR2.

On the completed capture of the transmitted information by the transmitted information capture module 212, the encryption record acquisition module 214 requests the printer PRT1 as the sender of the transmitted information to send the encryption record stored in the storage device STR1 of the printer PRT1. The encryption record acquisition module 214 obtains the encryption record sent from the printer PRT1 in response to the request. The obtained encryption record is stored into the encryption record storage unit 284 set in the storage device STR2 via the storage device I/F 270.

The comparative information generation module 216 encrypts transmission object information included in the encryption record stored in the encryption record storage unit 284 with a session key correlated to the transmission object information and included in the encryption record to generate comparative information. The details of the generation of the comparative information will be described later. The comparative information is stored into the comparative information storage unit 286 set in the storage device STR2.

The transmitted information verification module 218 compares the encrypted transmitted information obtained from the transmitted information captured by the transmitted information capture module 212 with the comparative information generated by the comparative information generation module 216. Based on the result of the comparison, it is determined whether the encrypted transmitted information includes any other piece of information than the transmission object information in the encryption record. The details of the comparison and determination will be described later.

The cooperation of the four functional blocks, the transmitted information capture module 212, the encryption record acquisition module 214, the comparative information generation module 216, and the transmitted information verification module 218, enables a transmitted information monitoring process to be executed by the transmitted information verification device ICS.

### A6. TRANSMITTED INFORMATION MONITORING PROCESS BY TRANSMITTED INFORMATION VERIFICATION DEVICE

The transmitted information verification device ICs executes the transmitted information monitoring process as described below.

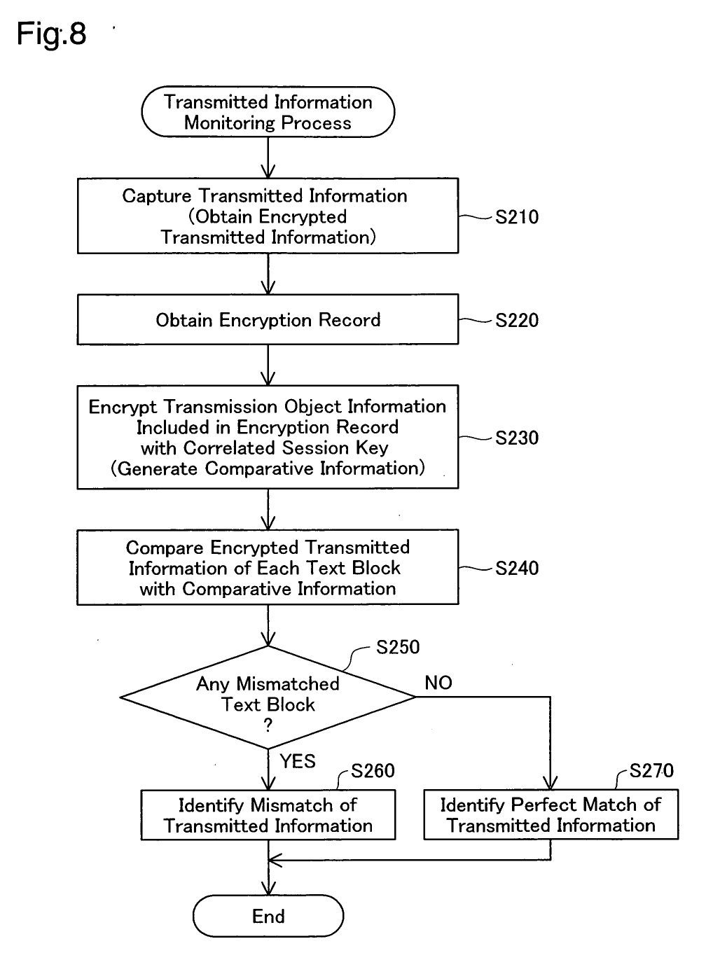

FIG. 8 is a flowchart showing the transmitted information monitoring process executed by the transmitted information verification device ICS. In response to a start command of monitoring transmitted information given by the user's operation of the keyboard KB or the mouse MS, the transmitted information capture module 212 captures transmitted information that is transferred on the local area network LAN1 from the printer PRT1 to the management server SV (see FIG. 1). The transmitted information capture module 212 then extracts encrypted transmission object information included in the captured transmitted information and stores the encrypted transmission object information as encrypted transmitted information into the transmitted information storage unit 282 set in the storage device STR2 (step S210). According to a concrete procedure, in response to a start command of monitoring the transmitted information given by the user's operation of the keyboard KB or the mouse MS, the transmitted information capture module 212 notifies the printer PRT1 of a start of monitoring the transmitted information via the local area network LAN1, captures the transmitted information that is transferred on the local area network LAN1 during a predetermined time period starting from the timing of notification, and stores the captured transmitted information into the transmitted information storage unit 282.

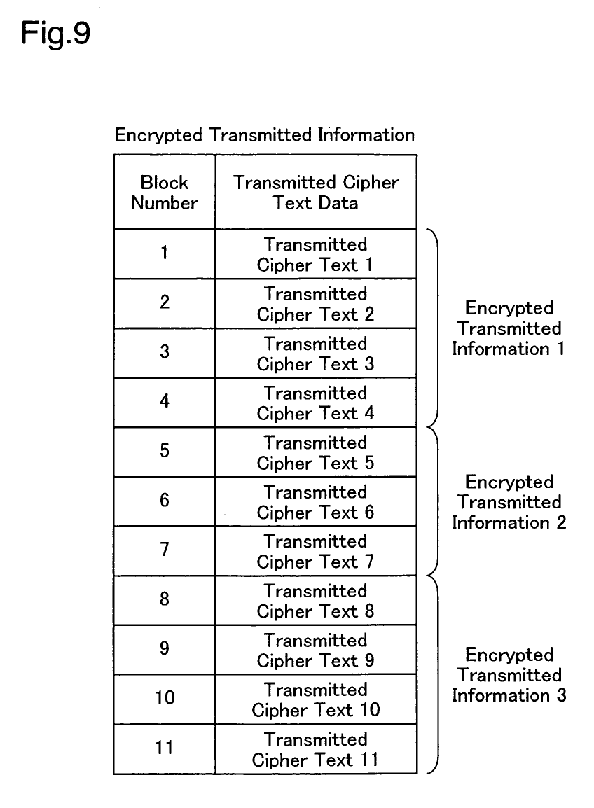

FIG. 9 shows one example of the encrypted transmitted information stored in the transmitted information storage unit 282. Sets of encrypted transmitted information obtained by capture of the transmitted information and divided by cipher text blocks as processing units of encryption are sequentially stored in relation to their block numbers. In the illustrated example of FIG. 9, data of transmitted cipher text blocks 1 to 11 are stored in relation to block numbers 1 to 11. The transmitted cipher text blocks 1 to 4 constitute encrypted transmitted information 1, the transmitted cipher text blocks 5 to 7 constitute encrypted transmitted information 2, and the transmitted cipher text blocks 8 to 11 constitute encrypted transmitted information 3. The sets of encrypted transmitted information 1 to 3 should be equal to the sets of encrypted transmission object information 1 to 3 shown in FIG. 4.

The encryption record acquisition module 214 obtains the encryption record stored in the encryption record storage unit 160 of the printer PRT1 and stores the encryption record into the encryption record storage unit 284 (step S220). The encryption record stored into the encryption record storage unit 284 of the transmitted information verification device ICS is identical with the encryption record stored into the encryption record storage unit 160 of the printer PRT1 during the predetermined time period starting from the timing of notification when the transmitted information verification device ICS notifies the printer PRT1 of a start of monitoring the transmitted information.

The comparative information generation module 216 encrypts transmission object information in the encryption record stored in the encryption record storage unit 284 with a correlated session key by the common key encryption system to generate comparative information and stores the generated comparative information into the comparative information storage unit 286 set in the storage device STR2 (step S230).

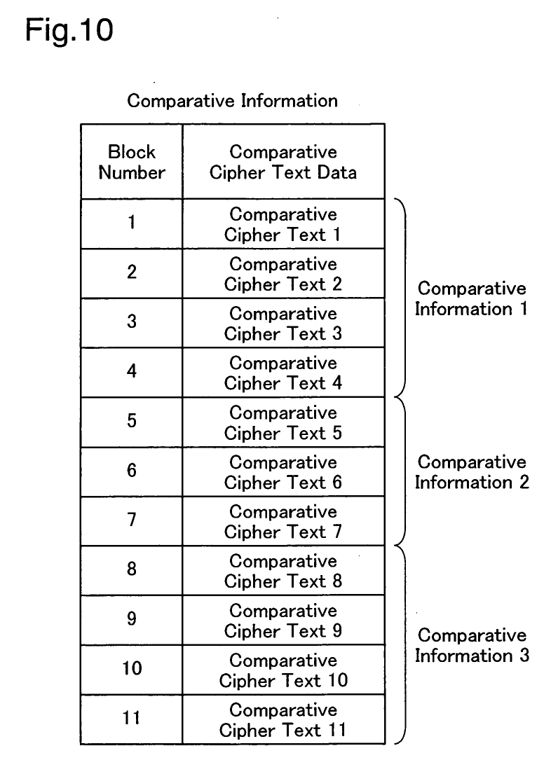

FIG. 10 shows one example of the comparative information stored in the comparative information storage unit 286. Sets of comparative information divided by comparative cipher text blocks are sequentially stored in relation to their block numbers. Each comparative cipher text block of the comparative information is obtained by encrypting each text block of the transmission object information with a correlated session key. In the illustrated example of FIG. 10, data of comparative cipher text blocks 1 to 11 are stored in relation to block numbers 1 to 11. The comparative cipher text blocks 1 to 4 constitute comparative information 1, the comparative cipher text blocks 5 to 7 constitute comparative information 2, and the comparative cipher text blocks 8 to 11 constitute comparative information 3.

The transmitted information verification module 218 compares the encrypted transmitted information of each text block stored in the transmitted information storage unit 282 with the comparative information of the same text block stored in the comparative information storage unit 286 (step S240). When the result of the comparison indicates the presence of any mismatched text block (step S250: Yes), the transmitted information monitoring process identifies mismatch of the transmitted information (step S260) and is terminated. When the result of the comparison indicates the absence of any mismatched text block (step S250: No), on the other hand, the transmitted information monitoring process identifies perfect match of the transmitted information (step S270) and is terminated.

### A7. EFFECTS OF EMBODIMENT

In the configuration of the embodiment described above, the printer PRT1 as the managed device encrypts transmission object information as a base of transmitted information and sends the encrypted transmission object information to the management server SV. The transmission object information is divided by plain text blocks as processing units of encryption. Information of each plain text block is correlated to information on a session key or a cipher key used for encryption of the plain text block. This correlation is stored as an encryption record in the storage device STR1 of the printer PRT1.

The transmitted information verification device ICS captures transmitted information that is transferred on the local area network LAN1 from the printer PRT1 to the management server SV and stores encrypted transmission object information included in the captured transmitted information and divided by cipher text blocks. The transmitted information verification device ICS acquires an encryption record corresponding to the captured transmitted information from the printer PRT1, extracts transmission object information from the acquired encryption record, and encrypts each plain text block of the transmission object information with a session key correlated to the plain text block to generate comparative information. The transmitted information verification device ICS then compares the generated comparative information of each text block with the encrypted transmitted information of the same text block and determines whether the transmitted information from the printer PRT1 to the management server SV perfectly matches with the transmission object information included in the encryption record.

The perfect match verifies that the encrypted transmitted information from the printer PRT1 to the management server SV does not include any other piece of information than the transmission object information in the encryption record. The transmitted information verification device ICS analyzes the transmission object information included in the encryption record and proves that the analyzed transmission object information does not include any piece of information that is not to be transmitted but is to be strictly kept in the user, for example, the user's any private or confidential piece of information. This verifies no transmission of any such private or confidential piece of information to the management server SV.

The information sent from the printer PRT1 as the managed device to the management server SV includes random digits used for creation of session keys and the created session keys, as well as the encrypted transmitted information. It is thus necessary to prove that data of each random digit or data of each session key does not include any piece of information that is not to be transmitted but is to be strictly kept in the user, for example, the user's any private or confidential piece of information.

The absence of any private or confidential piece of information in the data of each random digit transmitted to the management server SV is not directly provable, since the random digit does not have any explicit meaning. Each random digit has a significantly small bit number, for example, 1024 bits=128 letters. It is substantially impossible to conceal any bulk information in the data of each random digit. No transmission of any piece of information that is not to be transmitted but is to be strictly kept in the user, for example, the user's any private or confidential piece of information, in the data of each random digit is thus indirectly provable by recording and monitoring a variation in data volume transmitted as the data of each random digit.

The absence of any private or confidential piece of information in the data of each session key transmitted to the management server SV is proved in the following manner. The verification procedure records random digits exchanged with the management server SV and a session key creation algorithm and verifies that a session key created from the recorded random digits according to the session key creation algorithm is identical with a session key transmitted to the management server SV. This proves no transmission of any piece of information that is not to be transmitted but is to be strictly kept in the user, for example, the user's any private or confidential piece of information, in the data of each session key.

### B. MODIFICATIONS

The embodiment discussed above is to be considered in all aspects as illustrative and not restrictive. There may be many modifications, changes, and alterations without departing from the scope or spirit of the main characteristics of the present invention. Some examples of possible modification are given below.

### B1. MODIFIED EXAMPLE 1

In the configuration of the embodiment, the transmitted information verification device ICS gives a start command of monitoring the transmitted information to the printer PRT1 as the managed device and captures the transmitted information during a predetermined time period from the monitor start timing. The transmitted information verification device ICS also acquires an encryption record after this monitor start timing from the printer PRT1and encrypts each text block of transmission object information included in the acquired encryption record with a correlated session key. The encryption generates comparative information of each text block corresponding to each transmitted cipher text block. This procedure is, however, not restrictive. In one possible modification, the transmitted information verification device ICS does not give a start command of monitoring the transmitted information to the printer PRT1 but captures the transmitted information independently. This modified arrangement can not accurately specify a corresponding part of the encryption record to the captured transmitted information. The modified procedure thus acquires a certain range of the encryption record including at least the corresponding part from the storage of the printer PRT1, generates comparative information from the acquired encryption record, and detects the position of a text block of the generated comparative information corresponding to a first text block of the encrypted transmitted information. This identifies the position of a text block of the comparative information corresponding to each text block of the encrypted transmitted information. After the positional identification, the modified procedure compares the comparative information of each text block with the encrypted transmitted information of the same text block.

### B2. MODIFIED EXAMPLE 2

In the configuration of the embodiment, the transmitted information verification device ICS obtains the encryption record via the local area network LAN1. The transmitted information verification device ICS may alternatively obtain the encryption record via any of diverse communication interfaces, such as USB or RS232C.

In another possible modification, a detachable storage device may be adopted for the storage device STR1 of the printer PRT1. The detachable storage device STR1 having the storage of the encryption record is detached from the printer PRT1 and is attached to the transmitted information verification device ICS to be used as the storage device STR2 of the transmitted information verification device ICS. The transmitted information verification device ICS then attains acquisition and storage of the encryption record. In this modified structure, the encryption record acquisition module 214 is not required but is omitted from the transmitted information verification device ICS.

### B3. MODIFIED EXAMPLE 3

In the configuration of the embodiment, the encryption record includes the transmission object information correlated to the session key (cipher key) used for encryption of the transmission object information, since the session key (cipher key) is not fixed but is changed. When a fixed cipher key is used for encryption of any transmission object information, however, the encryption record may include only encrypted transmission object information. In this modified application, the transmitted information verification device ICS obtains information on the fixed cipher key from the printer PRT1 as the managed device, independently of the encryption record.

### B4. MODIFIED EXAMPLE 4

The embodiment regards application of the transmitted information verification technique of the invention to the printers. This is, however, not restrictive but is only illustrative. The transmitted information verification technique of the invention may be applied to any of diverse devices that are connected to a management server via a network and are under management of the management server, for example, facsimiles, scanners, and copying machines.

Finally the present application claims the priority based on Japanese Patent Application No. 2005-293438 filed on Oct. 6, 2005, which is herein incorporated by reference.

What is claimed is:

1. A transmitted information verification device that verifies content of encrypted transmission object information sent from a managed device to a management server, where the managed device connecting with the management server via a network encrypts transmission object information, which is to be sent to the management server, to generate the encrypted transmission object information,
the transmitted information verification device comprising:
a transmitted information capture module that captures the encrypted transmission object information transferred on the network, as encrypted transmitted information;
a comparative information generation module that encrypts transmission object information, which is included in an encryption record created by the managed device, with a cipher key used for encryption of the transmission object information in the managed device to generate comparative information; and
a transmitted information verification module that compares the encrypted transmitted information with the generated comparative information for verification.

2. A transmitted information verification device in accordance with claim 1, wherein the cipher key used in the managed device is stored as part of the encryption record in correlation to the transmission object information encrypted with the cipher key, and
the comparative information generation module encrypts the transmission object information included in the encryption record with the cipher key correlated to the transmission object information to generate the comparative information.

3. A managed device that encrypts transmission object information and transmits the encrypted transmission object information to a management server connecting with the managed device via a network,
the managed device storing the encrypted transmission object information in correlation to a cipher key used for encryption of the transmission object information, as an encryption record.

4. A transmitted information verification method that verifies content of encrypted transmission object information sent from a managed device to a management server, where the managed device connecting with the management server via a network encrypts transmission object information, which is to be sent to the management server, to generate the encrypted transmission object information,
the transmitted information verification method comprising the steps of:
(a) capturing the encrypted transmission object information transferred on the network, as encrypted transmitted information;
(b) encrypting transmission object information, which is included in an encryption record created by the managed device, with a cipher key used for encryption of the transmission object information in the managed device to generate comparative information; and
(c) comparing the encrypted transmitted information with the generated comparative information for verification.

5. A computer program product that is executed by a computer to verify content of encrypted transmission object information sent from a managed device to a management server, where the managed device connecting with the management server via a network encrypts transmission object information, which is to be sent to the management server, to generate the encrypted transmission object information,
the computer program product comprising:
a first program code of capturing the encrypted transmission object information transferred on the network, as encrypted transmitted information;
a second program code of encrypting transmission object information, which is included in an encryption record created by the managed device, with a cipher key used for encryption of the transmission object information in the managed device to generate comparative information;
a third program code of comparing the encrypted transmitted information with the generated comparative information for verification; and
a computer readable medium that stores the first through third program codes.
